(19) United States
(12) Patent Application Publication
(10) Pub. No.: US 2023/0011931 A1
(43) Pub. Date: Jan. 12, 2023

(54) ELECTRICAL CONNECTOR

(71) Applicant: T-CONN PRECISION CORPORATION, NEW TAIPEI CITY (TW)

(72) Inventors: CHIEN-AN LIAO, NEW TAIPEI CITY (TW); CHIEN-CHUN LU, NEW TAIPEI CITY (TW)

(21) Appl. No.: 17/466,315

(22) Filed: Sep. 3, 2021

(30) Foreign Application Priority Data
Jul. 9, 2021 (TW) 110208059

(51) Int. Cl. H01R 9/24; H01R 24/60; H01R 13/6591

(52) U.S. Cl. CPC H01R 9/2483; H01R 24/60; H01R 13/65914

(57) ABSTRACT

An electrical connector has an upper terminal module, a lower terminal module, and a septum between the upper and the lower terminal modules. The upper terminal module includes an upper block and multiple upper conductive terminals partially covered by the upper block and partially exposed. The lower terminal module includes a lower block and multiple lower conductive terminals partially covered by the lower block and partially exposed. The septum is located between the upper and the lower terminal modules; among them, more than one upper conductive terminal and more than one lower conductive terminal are used for grounding, and are in electrical contact with the septum. The grounding structure design can eliminate resonance to optimize high-frequency characteristics.

### BACKGROUND OF THE INVENTION

### 1. Field of the Invention

The present invention is about an electrical connector, especially an electrical connector that uses a special grounding structure to eliminate resonance and optimizes high-frequency characteristics.

### 2. Description of the Related Art

One of the major targets of the development of electrical connectors is to have faster transmission speed. However, adopting high-frequency technology for high-speed transmission must also face the problem of frequency band interference.

Such a problem is no exception for the USB Type-C connector that has been widely favored in recent years. The USB Type-C connector inherits excellent characteristics of USB 3.1 at 10 Gbit/s high-speed transmission, and is further optimized to become the most widely used interface standard for connectors. However, as above-mentioned, the USB Type-C connector adopting high-speed transmission also faces the problem of high-frequency interference.

Even though developers claim that the USB Type-C connector has improved the capability of resisting electromagnetic interference and radio frequency interference, the optimization of its high-frequency characteristics is still waiting for further improvement in its anti-interference capability.

### SUMMARY OF THE INVENTION

In view of this, the main purpose of the present invention is to provide an electrical connector, which uses a special grounding structure to effectively prevent resonance, thereby optimizing the high-frequency characteristics of the electrical connector.

To achieve the foregoing purpose, the main technical means adopted is to make the foregoing electrical connector include:

an upper terminal module, including an upper block and multiple upper conductive terminals partially covered by the upper block and partially exposed, wherein more than one of the multiple upper conductive terminals is used for grounding;

a lower terminal module, including a lower block and multiple lower conductive terminals partially covered by the lower block and partially exposed, wherein more than one of the multiple lower conductive terminals is used for grounding; and

a septum located between the upper and the lower blocks of the upper and the lower terminal modules and forming electrical contact with the more than one upper conductive terminal and the more than one lower conductive terminal which are used for grounding.

The above-mentioned electrical connector makes the more than one upper conductive terminal and the more than one lower conductive terminal, which are used for grounding, electrically contact the septum previously used for shielding the upper terminal module and the lower terminal module from each other, thereby eliminating resonance and optimizing the high frequency characteristics of the electrical connector.

### BRIEF DESCRIPTION OF THE DRAWINGS

FIG. 1 is a perspective view of the present invention;

FIG. 2 is an exploded view of the present invention;

FIG. 3 is another exploded view of the present invention;

FIG. 4 is an exploded view of the present invention illustrating the relative positions among the upper conductive terminals, the septum and the lower conductive terminals;

FIG. 5 is a side view of the present invention;

FIG. 6 shows the relative positions in assembly among the upper conductive terminals, the septum and the lower conductive terminals; and

FIG. 7 shows the present invention in operation.

### DETAILED DESCRIPTION OF THE INVENTION

In the following, the technical solutions in the embodiments of the present invention will be clearly and fully described with reference to the drawings in the embodiments of the present invention. Obviously, the described embodiments are only a part of, not all of, the embodiments of the present invention. Based on the embodiments of the present invention, all other embodiments obtained by a person of ordinary skill in the art without creative efforts shall fall within the protection scope of the present invention.

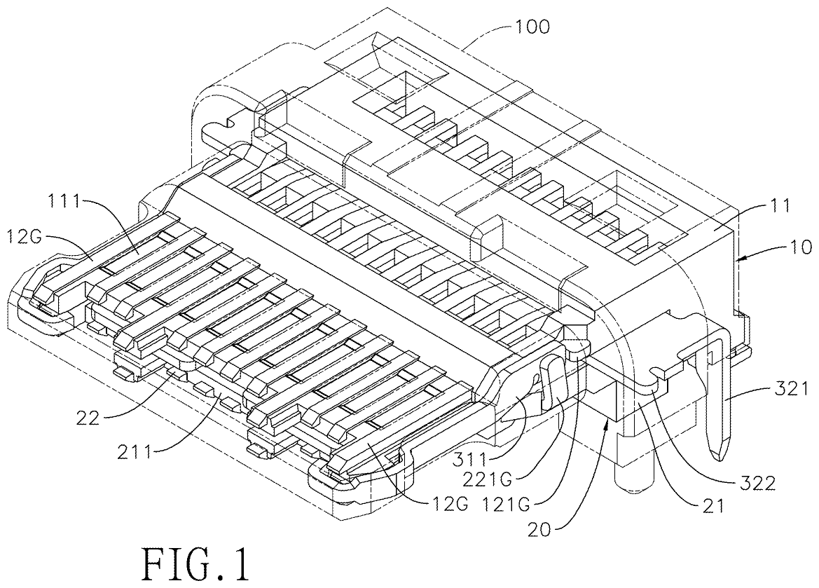

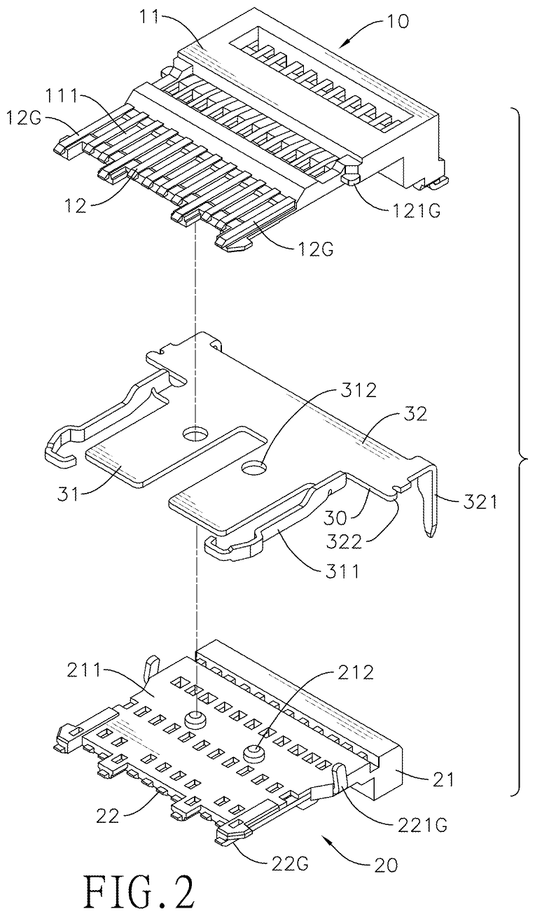

Regarding a preferred embodiment of the present invention, please refer to FIG. 1 and FIG. 2. It is mainly about an upper terminal module 10, a septum 30 and a lower terminal module 20 all configured in an outer covering body 100.

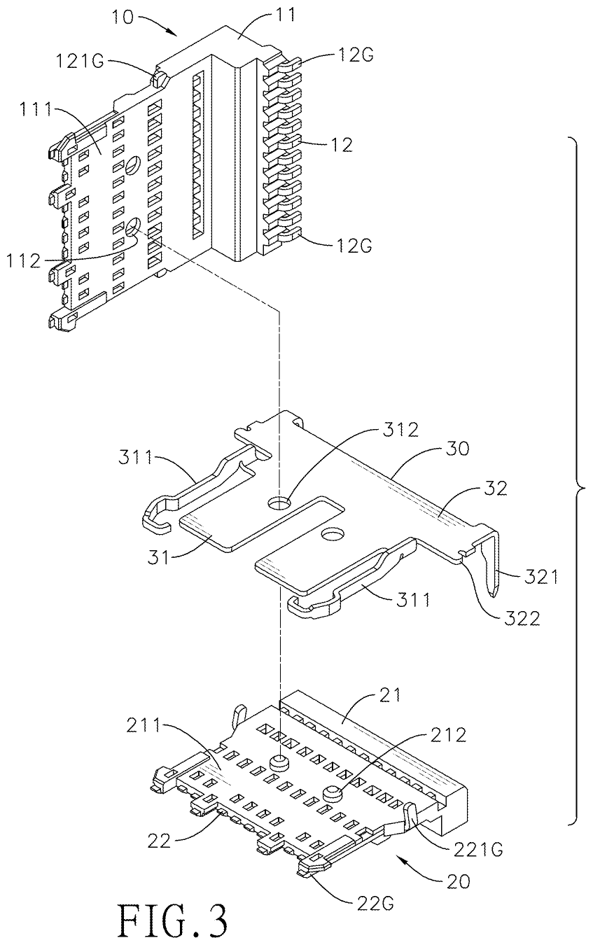

The upper terminal module 10 includes an upper block 11 and multiple upper conductive terminals 12, 12G, wherein, the upper block 11 has a front end and a rear end, and the front end extends outward horizontally and in one direction to form an upper tongue portion 111. Each of the multiple upper conductive terminals 12, 12G is partially covered by the upper block 11 and partially exposed. Further, a surface of one end of each of the multiple upper conductive terminals 12, 12G is exposed on a surface of the upper tongue portion 111, and the other end of each of the multiple upper conductive terminals 12, 12G extends from the rear end of the upper block 11 and is bent into a pin shape for electrical connection. Referring to FIG. 3, more than one wedge groove 112 is formed on the bottom surface of the upper block 11.

The lower terminal module 20 includes a lower block 21 and multiple lower conductive terminals 22, 22G, wherein, the lower block 21 has a front end and a rear end, and the front end extends outward horizontally and in one direction to form a lower tongue portion 211. Each of the multiple upper conductive terminals 22, 22G is partially covered by the lower block 21 and partially exposed. Further, a surface of one end of each of the multiple lower conductive terminals 22, 22G is exposed on a bottom surface of the lower tongue portion 211, and the other end of each of the multiple lower conductive terminals 22, 22G extends from the rear end of the lower block 21 and is bent into a pin shape for electrical connection. More than one wedge 212 is formed on a top surface of the lower block 21, and the more than one wedge 212 respectively corresponds to the more than one wedge groove 112 on the bottom surface of the upper block 11.

The septum 30 is located between the upper terminal module 10 and the lower terminal module 20 to shield each of the multiple upper conductive terminals 12, 12G and each of the multiple lower conductive terminals 22, 22G to reduce crosstalk. Specifically, the septum 30 is flat and located between the upper block 11 and the lower block 21. The septum 30 has a front piece 31 and a back piece 32 and the width of the front piece 31 is smaller than that of the back piece 32. Two sides of the front piece 31 respectively extend upward to form two first contact portions 311. The first contact portions 311 correspond to the two sides of the upper and the lower blocks 11, 21. The first contact portion 311 has a fixed end, and a free end which has an elongated elastic piece structure. Further, more than one wedge hole 312 is formed on the front piece 31, which corresponds to the more than one wedge groove 112 on the bottom of the upper block 11 and the more than one wedge 212 on the top of the lower block 21. When the upper and lower terminal modules 10, 20 are correspondingly integrated through the upper and lower blocks 11 and 21, the wedge 212 of the lower block 21 will pass through the corresponding wedge hole 312 on the front piece 31 of the septum 30, and then get wedged with the corresponding wedge groove 112 on the bottom of the upper block 11.

Both ends of the back side of the back piece 32 respectively extend downward to form two pins 321, and the two sides of the back piece 32 respectively extend outward to form a second contact portion 322.

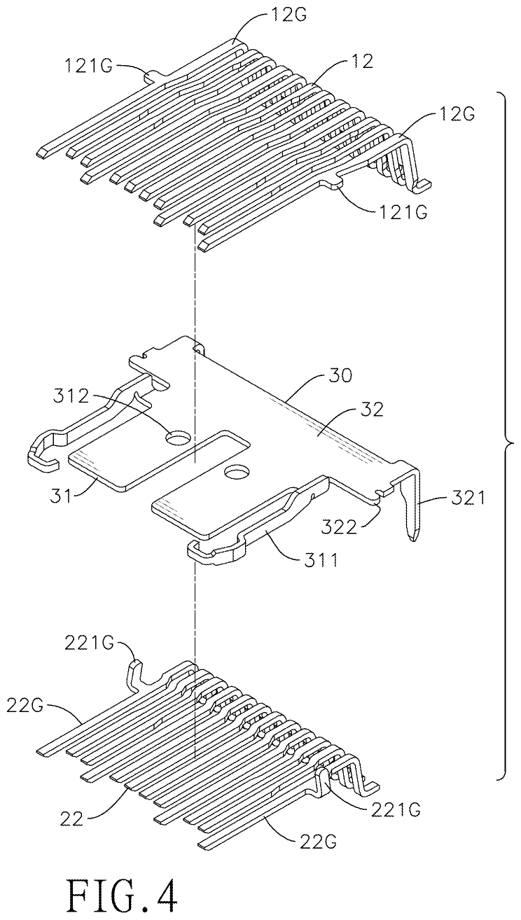

In order to further understand the detailed structure of the upper conductive terminals 12, 12G and the lower conductive terminals 22, 22G, please refer to FIG. 4. Two upper conductive terminals 12G respectively on opposite sides of the upper conductive terminals 12 are used for grounding. Further, two lower conductive terminals 22G respectively on opposite sides of the lower conductive terminals 22 are used for grounding. The present invention is mainly to make the more than one upper conductive terminal 12G and the more than one lower conductive terminal 22G, which are for grounding, electrically contact the septum 30 to eliminate resonance and optimize high frequency characteristics. In this embodiment, the present invention allows the two upper conductive terminals 12G and the two lower conductive terminals 22G, which are for grounding, to form electrical contact with the septum 30.

In order to make the two upper conductive terminals 12G and the two lower conductive terminals 22G, which are for grounding, to form electrical contact with the septum 30, two upper conductive terminals 12G respectively protrude outward beyond the outer sides of the corresponding opposite sides to form two protrusions 121G. The protrusions 121G will extend beyond the two sidewalls of the upper block 11 and correspondingly form electrical contacts with the fixed ends of the first contact portion 311 of the septum 30. Furthermore, the two lower conductive terminals 22G also protrude on the outer sides of the opposite sides to form two L-shaped lugs 221G. The lugs 221G will extend beyond the two sidewalls of the lower block 21 and correspondingly form electrical contacts with outer surfaces of the fixed ends of the first contact portion 311 of the septum 30.

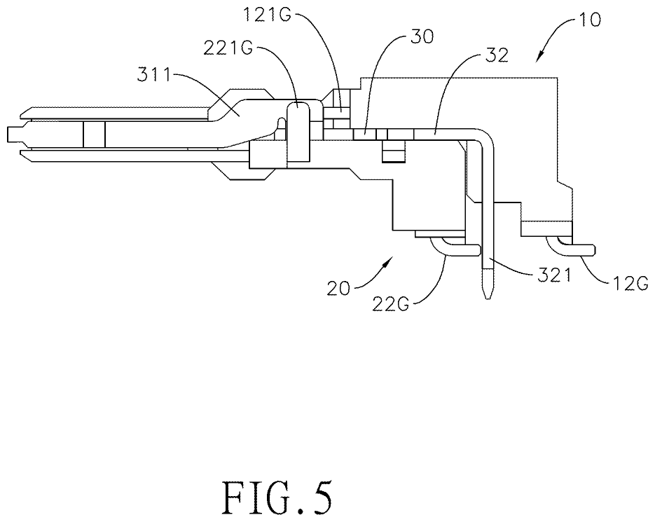

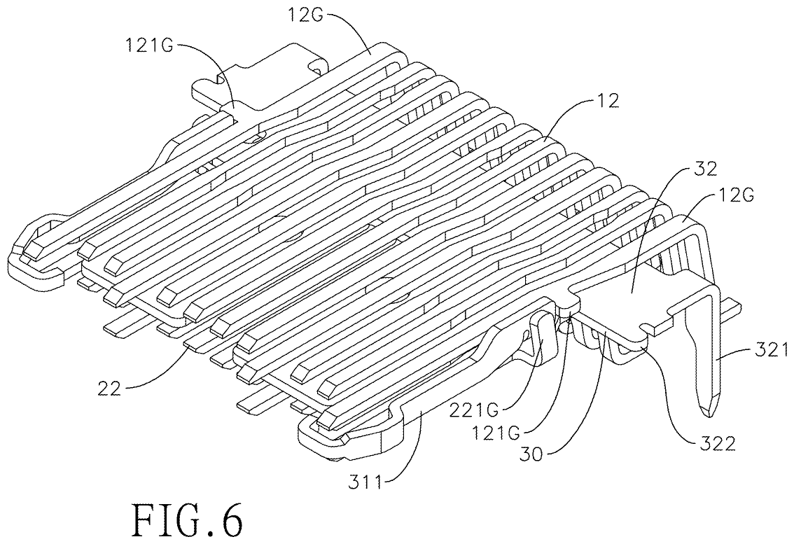

FIG. 5 shows that the upper terminal module 10, the septum 30, and the lower terminal module 20 are integrated. The upper conductive terminal 12G and the lower conductive terminal 22G, which are used for grounding, form electrical contacts with the first contact portion 311 of the septum 30 respectively. Please also refer to FIG. 6 for relative positions.

After the upper terminal module 10, the septum 30 and the lower terminal module 20 are integrated with each other, the outer covering body 100 is formed on the outside thereof. Please refer to FIG. 1. The outer covering body 100 covers the upper and the lower blocks 11, 21, while the upper tongue portion 111 of the upper block 11 and the upper conductive terminals 12, 12 G on the surface of the upper tongue portion 111, the lower tongue portion 211 of the lower block 21 and the lower conductive terminals 22, 22 G on the bottom surface of the lower tongue portion 211 (not shown in this figure) are exposed outside the two sidewalls of the body 100.

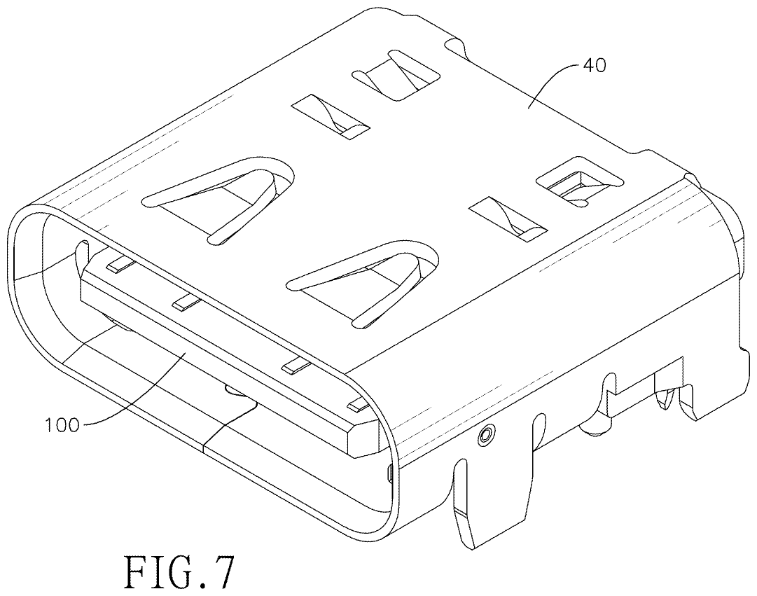

Please refer to FIG. 7, the outer covering body 100 is further sheathed with a metal shell 40. The inner wall surface of the metal shell 40 contacts the second contact portion 322 (not shown in FIG. 7) of the septum 30 which is exposed on two outer sidewalls of the outer covering body 100.

According to the aforementioned, the electrical connector is provided with a septum between the upper terminal module and the lower terminal module. The septum is used to shield the upper conductive terminals and the lower conductive terminals to reduce crosstalk. The present invention further makes the upper and the lower conductive terminals, which are for grounding, electrically contact the septum, thereby a grounding structure is augmented so as to eliminate resonance, and therefore the high-frequency characteristics are optimized. By forming respective tiny structures on the upper and the lower conductive terminals and the septum, and by forming electrical contacts among the tiny structures, the present invention implements grounding to enhance high-frequency characteristics without affecting the overall volume. Therefore, compared with the prior art, the present invention is new and non-obvious, and has a significant improvement in functionality.

The aforementioned are preferred embodiments of the present invention. It should be noted that for those of ordinary skill in the art, without departing from the principles of the present invention, certain improvements and retouches of the present invention can still be made which are nevertheless considered as within the protection scope of the present invention.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. An electrical connector, including:
an upper terminal module, including an upper block and multiple upper conductive terminals partially covered by the upper block and partially exposed, wherein more than one of the multiple upper conductive terminals is used for grounding;
a lower terminal module, including a lower block and multiple lower conductive terminals partially covered by the lower block and partially exposed, wherein more than one of the multiple lower conductive terminals is used for grounding; and
a septum located between the upper and the lower blocks of the upper and the lower terminal modules and forming electrical contact with the more than one upper conductive terminal and the more than one lower conductive terminal which are used for grounding.

2. The electrical connector as claimed in claim 1, wherein
two of the multiple upper conductive terminals respectively on opposite sides of the multiple upper conductive terminals are used for grounding, and the two upper conductive terminals respectively protrude outward beyond the outer sides of the corresponding opposite sides thereof to form a protrusion;
two of the multiple lower conductive terminals respectively on opposite sides of the multiple lower conductive terminals are used for grounding, and the two lower conductive terminals respectively protrude outward beyond the outer sides of the corresponding opposite sides thereof to form a lug; and
the septum has a front piece, and two sides of the front piece respectively extend upward to form a first contact portion which forms electrical contacts with the corresponding protrusions and lugs respectively.

3. The electrical connector as claimed in claim 2, wherein
the two lugs of the two lower conductive terminals used for grounding are L-shaped.

4. The electrical connector as claimed in claim 2, wherein
the upper block has a front end and a rear end, and the front end extends outward in a same horizontal direction to form an upper tongue portion, and a surface of one end of each of the multiple upper conductive terminals is exposed on a surface of the upper tongue portion, and the other end of each of the multiple upper conductive terminals extends from the rear end of the upper block; and
the lower block has a front end and a rear end, and the front end of the lower block extends outward in a same horizontal direction to form a lower tongue portion, and a surface of one end of each of the multiple lower conductive terminals is exposed on a surface of the lower tongue portion, and the other end of each of the multiple lower conductive terminals extends from the rear end of the lower block.

5. The electrical connector as claimed in claim 4, wherein
more than one wedge groove is formed on a bottom surface of the upper block and more than one wedge is formed on a top surface of the lower block, and the more than one wedge respectively correspond to the more than one wedge groove on the bottom surface of the upper block;
more than one wedge hole is formed on the front piece of the septum, and the more than one wedge hole respectively corresponds to the more than one wedge groove of the upper block and the more than one wedge of the lower block.

6. The electrical connector as claimed in claim 2, wherein
the septum has a back piece, and the width of the front piece is smaller than the width of the back piece, and two ends of a back side of the back piece respectively extend downward to form a pin, and two sides of the back piece respectively extend outward to form a second contact portion.

7. The electrical connector as claimed in claim 6, wherein
an outer covering body is formed on the outside of the upper terminal module, the septum and the lower terminal module; the outer covering body covers the upper and the lower blocks, the upper tongue portion of the upper block and the upper conductive terminals on the surface of the upper tongue portion, the lower tongue portion of the lower block and the lower conductive terminals on the bottom surface of the lower tongue portion are exposed outside the outer covering body.

8. The electrical connector as claimed in claim 7, wherein
the second contact portion of the septum is exposed from two sidewalls of the outer covering body.

9. The electrical connector as claimed in claim 8, wherein
the outer covering body is sheathed with a metal shell and an inner wall surface of the metal shell contacts the second contact portion of the septum.
